(19) United States
(12) Patent Application Publication
(10) Pub. No.: US 2018/0321525 A1
(43) Pub. Date: Nov. 8, 2018

(54) OPTICAL FILM COMPONENTS, BACKLIGHT MODULES, AND DISPLAY DEVICES

(71) Applicant: Shenzhen China Star Optoelectronics Technology Co. Ltd., Shenzhen, Guangdong (CN)

(72) Inventor: Zanjia SU, Shenzhen, Guangdong (CN)

(73) Assignee: Shenzhen China Star Optoelectronics Technology Co. , Ltd., Shenzhen, Guangdong (CN)

(21) Appl. No.: 15/556,054

(22) PCT Filed: Jul. 18, 2017
(86) PCT No.: PCT/CN2017/093252

§ 371 Date: Sep. 6, 2017

(30) Foreign Application Priority Data
May 4, 2017 (CN) 201710309559.6

(51) Int. Cl. G02F 1/1335; F21V 8/00; B32B 7/02; B32B 7/12

(52) U.S. Cl. CPC G02F 1/1336; G02B 6/005; B32B 7/02; B32B 7/12; B32B 2457/20; G02F 2202/36; B32B 2250/05; B32B 2307/422; B32B 2307/416; G02F 2001/133614

(57) ABSTRACT

The present disclosure relates to an optical film component, a backlight module, and a display device. The backlight module includes a light source, a first optical film, and a second optical film bonded together. The light source is configured to emit at least first light beams. The first optical film is a light conversion film configured to receive the first light beams, to transform the first light beams into at least one second light beams, and to emit the at least second light beams. As such, the performance of image display may be improved and the thickness of the backlight module may be reduced.

### BACKGROUND

### 1. Technical Field

The present disclosure relates to liquid crystal panel display field, more particularly to an optical film component, a backlight module, and a display device.

### 2. Description of Related Art

Liquid crystal display (LCD) has become the main product of the flat display field due to the attributes, such as thin, low power consuming, and no radiation. The LCDs have been widely adopted in the electrical devices, such as high digital (HD) TVs, desktop computers, tablets, laptops, mobile phones, and digital cameras.

With a variety of the electrical devices have become thinner, the LCDs also have become much thinner. However, with the thinner LCDs, the contrast and the color saturation may be degraded. The optical thin films have to be arranged in the backlight module to enhance color gamut, brightness, contrast, and color saturation of the LCDs, which may increase and restrict the thickness of the LCDs.

### SUMMARY

The present disclosure relates to an optical film component, including: a first optical film, a second optical film, and a third optical film being bonded together; the first optical film is a light conversion film configured to receive first light beams, to transform the first light beams into at least second light beams, and to emit the at least second light beams, wherein the first optical film comprises light transform material, the light transform material is configured to be quantum dot (QD) material and/or fluorescent material; the third optical film is attached to one side of the first optical film facing away the second optical film; the first optical film being completely wrapped by the second optical film and the third optical film.

In another aspect, the present disclosure relates to a backlight module, including: a light source configured to emit at least first light beams; a first optical film and a second optical film bonded together; wherein the first optical film is a light conversion film configured to receive the first light beams, to transform the first light beams into at least one second light beams, and to emit the at least second light beams.

In another aspect, the present disclosure relates to a display device, including the backlight module.

In view of the above, the present disclosure relates to the backlight module. The backlight module includes the first optical film and the second optical film bonded together. The first optical film is configured to be the light conversion film. The light conversion film is tightly attached to the other optical films to form the integrated attaching structure. The composite film layer has the function of the light conversion film and the other optical films. Such that, the performance of the image display may be improved. The two film layers may support each other, so that the stiffness may be improved, and the thickness of the backlight module may be reduced.

### BRIEF DESCRIPTION OF THE DRAWINGS

FIG. 1 is a schematic view of a backlight module in accordance with one embodiment of the present disclosure.

FIG. 2 is a schematic view of a first optical film in accordance with one embodiment of the present disclosure.

FIG. 3 is a schematic view of a second optical film in accordance with one embodiment of the present disclosure.

FIG. 4 is a schematic view illustrating different types of attachment between a first optical film and a second optical film.

FIG. 5 is a schematic view illustrating different types of attachment between a first optical film and a second optical film.

FIG. 6 is a schematic view illustrating different types of attachment between a first optical film and a second optical film.

FIG. 7 is a schematic view of an optical component in accordance with one embodiment of the present disclosure.

FIG. 8 is a schematic view of a display device in accordance with one embodiment of the present disclosure.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown. The figure and the embodiment described according to figure are only for illustration, and the present disclosure is not limited to these embodiments.

Referring to FIG. 1, the present disclosure relates to a backlight module configured to provide backlight to a display device. The backlight module may include: a light source 101, a first optical film 102, and a second optical film 103.

The light source 101 may be a point light source, a line light source, and a surface light source configured to emit at least first light beams. In one example, the light source may be a light emitting diode (LED). The LED is configured to emit a variety colors of light beams, such as ultra-violet (UV) light and blue light. In another example, the light source may be a chip configured to emit the light beams.

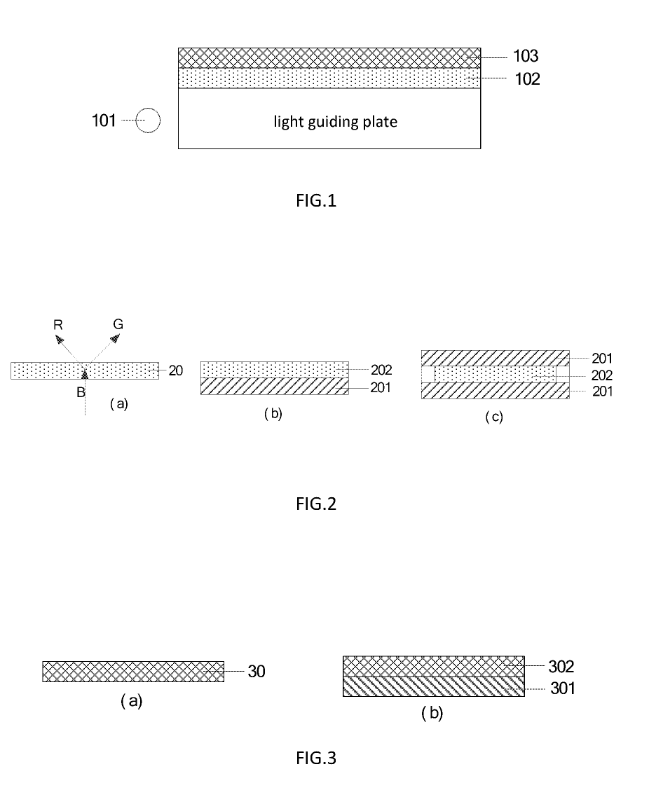

Referring to FIG. 2, FIG. 2 is a schematic view of a first optical film in accordance with one embodiment of the present disclosure. The first optical film 20 may be a light conversion film configured to receive first light beams, to transform the first light beams into at least second light beams, and to emit the at least second light beams. In one example, the first light beams may be the UV light or the blue light, the second light beams may be yellow light, mixed light beams of green light and red light, or mixed light beams of the blue light, the green light, and red light.

In one embodiment, the light conversion film only may include a light conversion material layer. The light conversion material layer may include light conversion material distributed in polymer material. Wherein the polymer material may include photo initiators, acrylate polymers, epoxy resins, or polymers containing both acrylate and epoxy polymers.

The light transform material may include quantum dot (QD) material and/or fluorescent material. The QD indicates a dimensional size of particle material is in Nano-scale. The QD may be turn into an excited state when receiving the light beams, and may emit specific wavelength (specific color) light beams when turning back to a ground state from the excited state. An emission spectrum of the QD is controlled by the size of the QD, such that, the emission spectrum of the QD may be adjusted by changing the size of the QD. The QD has attributes, such as high conversion efficiency, which may improve the utilization of light beams, half-wave width of the emission spectrum of the QD is narrow, and good temperature stability. The QD material may be adopted in the light conversion film, as such, efficiency of light excitation and the color gamut may be improved, the viewing angle may be increase, and the image display performance of the LCD may be enhanced.

In one example, the QD material may be the QD material in II-VI group, in group, in III-V group, or a mixture of different the QD material. The QD material in II-VI group indicates compounds form by mixing II group elements and VI group elements. The QD material in group indicates compounds form by mixing I group elements, III group elements, and the VI group elements. The QD material in III-V group indicates compounds form by mixing III group elements and V group elements. Specifically, the QD material may be at least one of ZnCdSe₂, CdSe, CdTe, CUInS₂, ZnCuInS₃, CdS, HgTe, ZnS, ZnSe, ZnTe, HgS, InP, InAs, GaP, GaAs, and carbon QD. The size, material, and types of fluorescent material are adjustable according to the demand. In one example, the size of the QD material may be in a range from 1 nm to 20 nm, such as 1 nm, 5 nm, 8 nm, 15 nm, and 20 nm.

The QD material may include blue light QD material, green light QD material, and red light QD material. When adopting the blue light as the light source, the light conversion material may include the green light QD material and the red light QD material. When adopting the blue light and green light as the light source, the light conversion material may include the red light QD material. When adopting the blue light and the red light as the light source, the light conversion material may include the green light QD material. Adopting high color saturation LCD backlight light source may improve the color saturation of the LCD.

Referring to FIG. 2, in one embodiment, the light conversion film 20 may include the light conversion material layer 202 and a first base layer 201 configured on at least one side of the light conversion material layer. The first base layer 201 is a carrier configured to bearer or support the light conversion material layer 202. A base material of the first base layer 201 may be glass material or organic polymer material, for example, the base material may be at least one of PET, PC, PI COP, and TAC. An inorganic barrier layer, such as SiOx, SiNx, AlOx, or TiOx may be coated on an upper surface and a down surface of the base material.

Referring to FIG. 2, in one embodiment, the light conversion film 20 may include the light conversion material layer 202 and the two first base layers 201 configured on two sides of the light conversion layer 202, wherein the light conversion film 202 is completely wrapped by the two first base layers 201. Specifically, the light conversion material is sensitive to water vapor and oxygen, so that it may be fail when using. The two first base layer is adopted to completely wrap the light conversion material layer, such that a sealed package process may be conducted on the light conversion material layer to protect the light conversion material layer. As such, a protect layer may be excluded, the cost may be reduced, the process may be simplified, and the thickness of the light conversion film may be reduced.

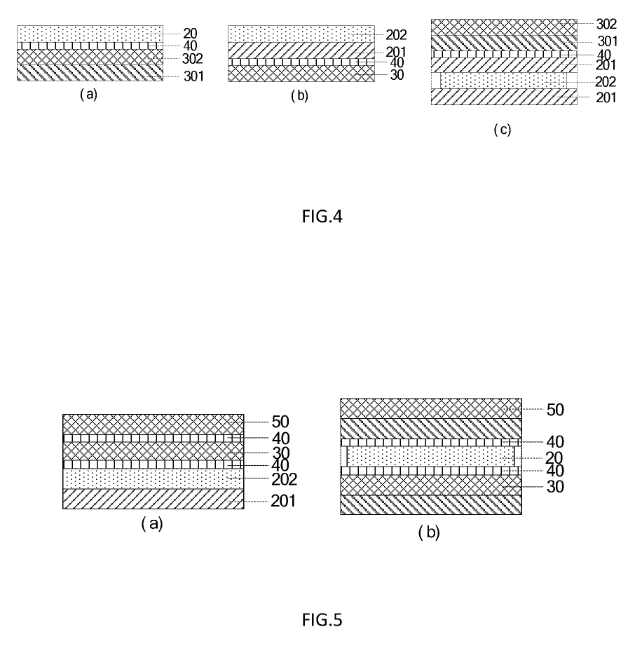

Referring to FIG. 3, in one embodiment, the second optical film 30 includes a second base layer 301 and a function layer 302 stacked on the second base layer 301. The second base layer 301 is configured on one side of the function layer facing toward or facing away the first optical film 302. The second base layer 301 is a carrier configured to bearer or support the function layer. A base material of the second base layer 301 may be glass material or organic polymer material. Referring to FIG. 4, the second optical film 30 may attach to and support the first optical film 20, wherein the first optical film 20 excludes the first base layer 201, so as to reduce the thickness of the backlight module.

Referring to FIG. 2, FIG. 3, and FIG. 4, in one embodiment, the second optical film 30 may only include the function layer 302 and exclude the second base layer 301. The second optical film 30 is attached to the first optical film 20. The first optical film 20 is configured to be the carrier to bearer or support the function layer 302, such that the thickness of the backlight module may be reduced. In another embodiment, the first optical film 20, including the base layer, may be attached to the second optical film 30.

Wherein the second optical film 30 may be one of a diffusion film, a bright film, a reflective film, a micro-lens film, a prism film, and a dual brightness enhancement film (DBEF). The second optical film 30 is configured on the first optical film 20, so as to increase brightness, enhance shielding, and improve performance of image display. In view of the above, the light conversion film, which is manufactured separately, may be attached to a variety of the optical films to obtain an integrate structure having the function of the light conversion film and the other optical films, so as to achieve high color gamut and thin shape. In another embodiment, a variety of optical film layers having the same function or having different functions may be configured on the first optical film 20. For example, a third optical film, a fourth optical film, and a fifth optical film. A plurality of film layers may attach to each other via a specific sequence.

Referring to FIG. 5, in one embodiment, the backlight module may further include the third optical film 50 attached on one side of the first optical film 20 facing away the second optical film 30. Or the third optical film 50 may attach to one side of the second optical film 30 facing away the first optical film 20. The second optical film 30 is the same with or different from the function layer of the third optical film 50.

Referring to FIG. 5, in one embodiment, the third optical film 50 is attached to one side of the first optical film 20 facing away the second optical film 30. The first optical film 20 may exclude the first base layer 201. The first optical film 20 is completely wrapped by the second optical film 30 and the third optical film 50. As such, the light conversion layer may be protected, the protect layer and the first base layer may be excluded, the cost may be reduced, and the thickness of the light conversion film may be reduced.

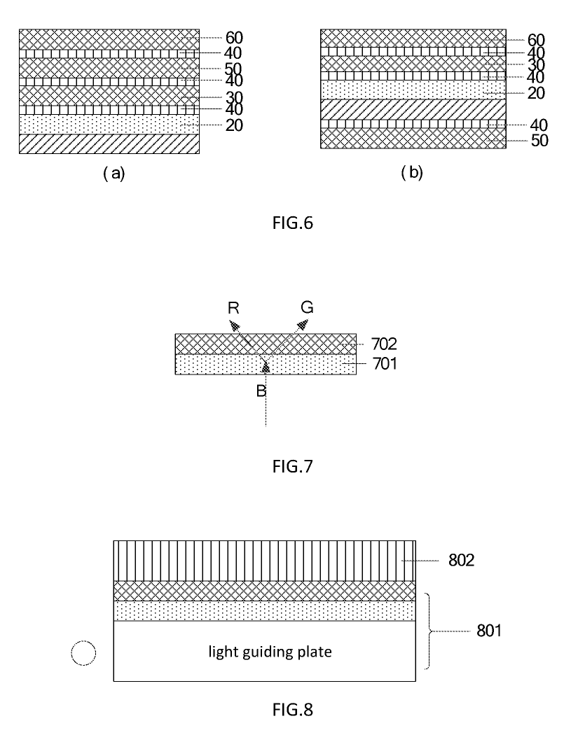

Referring to FIG. 6, in one embodiment, the backlight module may further include a fourth optical film 60. The first optical film 20, the second optical film 30, the third optical film 50, and the fourth optical film 60 are stacked in sequence; or the first optical film 20 is configured between any two of the second optical film 30, the third optical film 50, and the fourth optical film 60. By arranging the third optical film 50 and the fourth optical film 60, wherein the fourth optical film 60 may have the same function of have different functions with the third optical film 60, the performance of image display may be improved.

Referring to FIGS. 4 to 6, in one embodiment, the backlight module may further include an adhesive layer 40 configured between the first optical film 20 and the second optical film 30. Wherein the first optical film 20 is configured within an optical path between the second optical film 30 and a light source, or the second optical film 30 is configured within an optical path between the first optical film 20 and the light source. In one example, the adhesive layer 40 may be an UV curing colloid or a thermosetting colloid, and a thickness of the adhesive may be in a range from 1 um to 10 um, for example, 1 um, 3 um, 5 um, 7 um, and 10 um.

In view of the above, the light conversion film may be attached to a variety of the optical films to obtain an integrate structure having the function of the light conversion film and the other optical films, so as to achieve high color gamut and thin shape. The color gamut may be maintained at the same level with the separate film structure, and the thickness of the base material may be further reduced by 25-100 um, so as to reduce the thickness of the LCD.

In another example, the backlight module may be configured to be a vertical light source to provide the backlight light source to the display device.

Referring to FIG. 7, the present disclosure relates to an optical component. The optical component may include the first optical film 701 and the second optical film 702 bonded together. Wherein the first optical film 701 may be the light conversion film, and the light conversion film is configured to receive first light beams, to transform the first light beams into at least second light beams, and to emit the at least second light beams. The optical module has the same structure with the above embodiment, and may not be described again. The optical film component may be adopted in the backlight module field and illumination field.

Referring to FIG. 8, the present disclosure relates to a display device. The display device may include the backlight module 801 and a LCD panel 802. The backlight module 801 has the same structure with the above embodiment, and may not be described again. The structure of the LCD panel 802 may adopt a conventional LCD structure. The backlight module of the display device has a greater light emitting angle, such that, the display device may have a greater viewing angle and may have a greater image display performance.

In view of the above, the present disclosure relates to the backlight module. The backlight module includes the first optical film and the second optical film bonded together. The first optical film is configured to be the light conversion film. The light conversion film is tightly attached to the other optical films to form the integrated attaching structure. The composite film layer has the function of the light conversion film and the other optical films. Such that, the performance of the image display may be improved. The two film layers may support each other, so that the stiffness may be improved, and the thickness of the backlight module may be reduced.

The above description is merely the embodiments in the present disclosure, the claim is not limited to the description thereby. The equivalent structure or changing of the process of the content of the description and the figures, or to implement to other technical field directly or indirectly should be included in the claim.

What is claimed is:

1. An optical component, comprising:
a first optical film, a second optical film, and a third optical film being bonded together;
the first optical film is a light conversion film configured to receive first light beams, to transform the first light beams into at least second light beams, and to emit the at least second light beams, wherein the first optical film comprises light transform material, the light transform material is configured to be quantum dot (QD) material and/or fluorescent material;
the third optical film is attached to one side of the first optical film facing away the second optical film;
the first optical film being completely wrapped by the second optical film and the third optical film.

2. The optical component according to claim 1, wherein the light conversion film only comprises a light conversion material layer; or
the light conversion film comprises the light conversion material layer and a first base layer configured on at least one side of the light conversion layer; or
the light conversion film comprises the light conversion material layer and the first base layers configured on two sides of the light conversion layer, wherein the light conversion film is completely wrapped by the two first base layers.

3. The optical component according to claim 1, wherein the second optical film comprises a second base layer and a function layer stacked on the second base layer, wherein the second base layer is configured on one side of the function layer facing toward or facing away the first optical film; or
the second optical film only comprises the function layer and excludes the second base layer, and the second optical film is one of a diffusion film, a bright film, a reflective film, a micro-lens film, a prism film, and a dual brightness enhancement film.

4. The optical component according to claim 1, wherein the component further comprises: an adhesive layer configured between the first optical film and the second optical film;
wherein the first optical film is configured within an optical path between the second optical film and a light source, or the second optical film is configured within an optical path between the first optical film and the light source.

5. A backlight module, comprising:
a light source configured to emit at least first light beams;
a first optical film and a second optical film bonded together;
wherein the first optical film is a light conversion film configured to receive the first light beams, to transform the first light beams into at least one second light beams, and to emit the at least second light beams.

6. The backlight module according to claim 5, wherein the light conversion film only comprises a light conversion material layer; or
the light conversion film comprises the light conversion material layer and a first base layer configured on at least one side of the light conversion layer; or
the light conversion film comprises the light conversion material layer and the first base layers configured on two sides of the light conversion layer, wherein the light conversion film is completely wrapped by the two first base layers.

7. The backlight module according to claim 5, wherein the second optical film comprises a second base layer and a function layer stacked on the second base layer, wherein the second base layer is configured on one side of the function layer facing away or facing away the first optical film; or
the second optical film only comprises the function layer and excludes the second base layer, and
the second optical film is one of a diffusion film, a bright film, a reflective film, a micro-lens film, a prism film, and a dual brightness enhancement film.

8. The backlight module according to claim 5, wherein the backlight module further comprises:
a third optical film attached to one side of the first optical film facing away the second optical film; or
the third optical film attached to one side of the second optical film facing away the first optical film;
wherein the second optical film is the same with or different from the function layer of the third optical film.

9. The backlight module according to claim 5, wherein the backlight module further comprises:
a third optical film attached to one side of the first optical film facing away the second optical film, wherein the first optical film is completely wrapped by the second optical film and the third optical film.

10. The backlight module according to claim 5, wherein the backlight module further comprises a fourth optical film;
wherein the first optical film, the second optical film, the third optical film, and the fourth optical film are stacked in sequence; or the first optical film is configured between any two of the second optical film, the third optical film, and the fourth optical film.

11. The backlight module according to claim 5, wherein the backlight module further comprises an adhesive layer configured between the first optical film and the second optical film;
the first optical film is configured within an optical path between the second optical film and a light source, or the second optical film is configured within an optical path between the first optical film and the light source.

12. The backlight module according to claim 5, wherein the first optical film comprises light transform material, and the light transform material is configured to be QD material and/or fluorescent material.

13. A display device, comprising a backlight module, wherein the backlight module comprises:
a light source configured to emit at least first light beams;
a first optical film and a second optical film bonded together;
wherein the first optical film is a light conversion film configured to receive the first light beams, to transform the first light beams into at least one second light beams, and to emit the at least second light beams.

14. The display device according to claim 13, wherein the light conversion film only comprises a light conversion material layer; or
the light conversion film comprises the light conversion material layer and a first base layer configured on at least one side of the light conversion layer; or
the light conversion film comprises the light conversion material layer and the first base layers configured on two sides of the light conversion layer, wherein the light conversion film is completely wrapped by the two first base layers.

15. The display device according to claim 13, wherein the second optical film comprises a second base layer and a function layer stacked on the second base layer, wherein the second base layer is configured on one side of the function layer facing toward or facing away the first optical film; or
the second optical film only comprises the function layer and excludes the second base layer, and the second optical film is one of a diffusion film, a bright film, a reflective film, a micro-lens film, a prism film, and a dual brightness enhancement film.

16. The display device according to claim 13, wherein the backlight module further comprises:
a third optical film attached to one side of the first optical film facing away the second optical film; or
the third optical film attached to one side of the second optical film facing away the first optical film;
the second optical film is the same with or different from the function layer of the third optical film.

17. The display device according to claim 13, wherein the backlight module further comprises a fourth optical film;
wherein the first optical film, the second optical film, the third optical film, and the fourth optical film are stacked in sequence; or the first optical film is configured between any two of the second optical film, the third optical film, and the fourth optical film.

18. The display device according to claim 13, wherein the backlight module further comprises an adhesive layer configured between the first optical film and the second optical film;
the first optical film is configured within an optical path between the second optical film and a light source, or the second optical film is configured within an optical path between the first optical film and the light source.
